(19) United States
(12) Patent Application Publication
(10) Pub. No.: US 2023/0413961 A1
(43) Pub. Date: Dec. 28, 2023

(54) METHOD FOR MANUFACTURING A CERAMIC CASING ELEMENT, PARTICULARLY FOR HOROLOGY, AND CORRESPONDING CASING ELEMENT

(71) Applicant: MANUFACTURE D'HORLOGERIE AUDEMARS PIGUET SA, Le Brassus (CH)

(72) Inventors: Thibaut LE LOARER, Chavannaz (FR); Maxime GOVAERTS, Les Bioux (CH); Duncan DELEZINIER, Genève (CH)

(21) Appl. No.: 18/252,951

(22) PCT Filed: Nov. 16, 2021
(86) PCT No.: PCT/EP2021/081855

§ 371 Date: May 15, 2023

(30) Foreign Application Priority Data
Nov. 16, 2020 (CH) 01461/20

(51) Int. Cl. A44C 27/00; G04D 3/00; G04B 37/22

(52) U.S. Cl. CPC A44C 27/001; G04D 3/0069; G04B 37/225

(57) ABSTRACT

Disclosed is a method for manufacturing a casing element made of ceramic, for the fields of watchmaking or jewelry making, which enables a casing element to be obtained that is substantially homogeneous in terms of its structure and mechanical properties and that has variations of hue and/or color that are both original and unique on its surface. The manufacturing method includes, in particular, a machining step intended to make different layers, of different respective natures, visible on the surface of the casing element.

### TECHNICAL FIELD

The present invention relates to a method for manufacturing a ceramic casing element, for the fields of horology or of jewelry, making it possible to obtain a casing element that is substantially homogeneous from the point of view of its structure and of its mechanical properties and that exhibits variations of hue and/or of color on its surface.

The present invention relates also to such a casing element intended to be used in the fields of horology or of jewelry.

### STATE OF THE ART

Various methods for manufacturing ceramic elements are known by virtue of which the corresponding casing element exhibits several colors on its surface.

Thus, for example, the patent CH707424 B1 discloses a method for manufacturing ceramic casing elements for horology, that makes it possible to obtain such casing elements having two portions of different colors. To obtain such a result, a composition, comprising a powder intended to undergo a sintering operation to produce a ceramic as well as a first pigment, is prepared then shaped. Before the implementation of the sintering operation, the shaped piece is partially exposed to a treatment aiming to dope the exposed portion with a second pigment, preferably one or more metals, in such a way that the casing element that is finally obtained after the sintering operation exhibits two different colors between the portion treated with the second pigment and the untreated portion. According to the owner, this method advantageously makes it possible to produce casing elements that exhibit a clear and precise demarcation between the two portions, which notably is suitable in particular for the manufacturing of two-color bezels for dive watches or for the GMT function for example. In this case, one color is associated with the daytime hours and the other color is associated with the nighttime hours.

The publication JP 2014-12615 A discloses another method for producing casing elements, notably for horology, such as, for example, a bezel for a dive watch. This document describes embodiments according to which such a bezel can be manufactured so as to present a general envelope formed by a first ceramic, having a first predefined color and, inside which are produced inscriptions composed of a second ceramic having a second predefined color. To achieve such a result, the corresponding invention consists in injecting two different compositions into a same mold before making them undergo, together, a conventional sintering operation. The latter is directly followed by an “HIP” (“Hot Isostatic Pressure”) treatment operation, presented as being essential to ensure a good densification of the ceramic finally obtained, and therefore a good cohesion between the different regions of the final product respectively produced on the basis of different compositions.

In all cases, the method presented in this Japanese publication aims to produce a pattern that is precise and predefined, for the purposes of display or of decoration. As set out above, the method disclosed in the first prior document relates also to the manufacturing of a casing element that has display functionalities, which involves the implementation of a precise distribution between the ceramics of different colors, as is also the case in the production of a predefined pattern. Thus, these two methods fall within the general trend of the industrial research, which aims to define parameters of manufacturing methods that make it possible to implement reproducible operational conditions for producing parts, produced in greater or lesser numbers, which are identical to one another.

### DISCLOSURE OF THE INVENTION

A main aim of the present invention is to propose a method for manufacturing a ceramic casing element that is an alternative to the methods that are already known, that makes it possible to obtain casing elements exhibiting an original and unique appearance. Another aim of the invention is to propose a ceramic casing element, for a timepiece or piece of jewelry, that is substantially homogeneous from the point of view of its structure and of its mechanical properties and that exhibits an original appearance compared to the casing elements known from the prior art, notably at least two different hues and/or colors obtained in the mass.

To this end, the present invention relates more particularly to a method for manufacturing a ceramic casing element for the fields of horology or of jewelry, of the type indicated above, comprising the steps consisting in:
preparing a first basic composition, comprising a powder intended to undergo a sintering operation aiming to produce a ceramic,
preparing a second basic composition, comprising a powder intended to undergo a sintering operation aiming to produce a ceramic,
treating at least one of the first and second basic compositions, prior to the implementation of the sintering operation, to introduce therein at least one pigment and define first and second respective reagents,
the first and second reagents having respective natures that are similar but different from one another such that, when they are subjected together to a sintering operation, a ceramic product is obtained that is substantially homogeneous from the point of view of its structure and of its mechanical properties, and that the ceramic product finally obtained exhibits variations of hue and/or of color,
placing the first and second reagents in a mold in the form of at least two layers that are at least partially adjacent to define between them an interface of predefined form,
implementing a sintering operation applied to the mold containing the first and second reagents.

The method according to the invention is characterized by the fact that it comprises at least one step of machining of the ceramic product obtained after the sintering operation, comprising at least one material removal operation along a path intersecting the interface, in such a way that at least a portion of the interface is visible on the surface of the casing element and that the latter exhibits a unique appearance with variations of hue and/or of color on its surface, the distribution of which appears to be substantially random and is independent of any predefined pattern or of any function linked to the display of an indication.

The different colors can for example be identified conventionally by their coordinates in the L*a*b* space.

Advantageously, each basic composition comprises a powder intended to form a ceramic when it is subjected to a sintering operation, as well as a stabilizer and possibly a binder, as is known, in such a way that after introduction of the pigment or pigments, a reagent of green body type is obtained.

By virtue of these features, it is possible to control the general trend to which the ceramic product is oriented in terms of colors and of hues, while preserving freedom of transfer of the pigment or pigments at the interface of the two layers during the sintering operation, thus making a random contribution to the appearance of the product obtained after the sintering.

The subsequent machining step also makes it possible to produce two casing elements of significantly different appearance from a same ceramic product derived from the sintering, based on the path followed to perform the removal of material. Thus, the manufacturer can choose to further emphasize or, on the contrary, attenuate the variations of hue and/or of color on the surface of the casing element on the basis of a same ceramic product derived from the sintering.

It will also be noted that, generally, one difficulty that is known in the field of the manufacturing of ceramic elements lies in obtaining a good reproducibility of the colors and of the hues of the finished products. In particular, the greater the dimensions of an element, the more difficult it becomes to guarantee a perfect homogeneity of the colors and of the hues over its entire surface. Likewise, obtaining the same colors and hues for distinct different components of a complex product is difficult, as is the case for example for a watch middle, a case bottom, a time-setting crown, possible buttons, a bezel, even sometimes links, studs or wristlet buckles. Indeed, once these components are assembled with one another, the slightest possible variation of color or of hue between two adjacent components is immediately visible.

Returning to the manufacturing method according to the present invention, it also takes the opposite view to the conventional approach aiming to improve the reproducibility of a manufacturing method, notably in a case like this, by precisely controlling the hues and colors obtained for the manufactured casing element. Indeed, this method on the contrary makes it possible to play with palettes of colors and of hues to emphasize the variations not only on the surface of a given component, but also between adjacent components if appropriate. In so doing, this method makes it possible not only to lighten the load weighing on the manufacturer to precisely control the hues and colors of the products that he or she manufactures, but it also makes it possible to manufacture products with an original and unique appearance, running counter to the current general trend aiming to produce components of uniform appearance.

It will finally be noted that the method according to the present invention is distinguished clearly from the prior method cited above not only by the targeted result, that is to say the production of unique products rather than that of products that are all identical to one another, but also by a great simplification of the operation of placement of the reagents in the mold before the sintering operation since the casing element according to the invention is not intended to comprise a predefined pattern, as is the case of the casing elements obtained by the implementation of the prior methods mentioned above. Likewise, the machining step is clearly simplified compared to that disclosed in the abovementioned Japanese document since it aims only to free the general form of the casing element to be manufactured, without specific account being taken of the distribution of the colors or of the hues deriving from the different reagents placed in the mold before the sintering which would be essential to obtain a predefined pattern.

In the case of the present invention, provision can advantageously be made for the first and second reagents to be placed in the mold in the absence of any precise control on the manner in which they are distributed with respect to one another inside the mold and which would aim to produce a predefined pattern.

Generally, provision can be made for the interface between the layers placed in the mold to have a median plane and for the machining step to be performed in such a way that the casing element has at least one face defining a median general plane exhibiting an inclination with reference to the median plane of the interface of between 10 and 90°. Thus, an infinity of different casing elements can potentially be produced from a given ceramic product derived from the sintering, simply by modifying the path followed in the removal of material.

Advantageously, the method according to the invention can comprise a supplementary step of preparation of a third reagent, comprising a powder intended to undergo a sintering operation aiming to produce a ceramic, the third reagent having a nature that is similar but different from that of at least one out of the first and second reagents and being chosen in such a way that, when the first, second and third reagents are subjected together to a sintering operation, a ceramic product is obtained that is substantially homogeneous from the point of view of its structure and of its mechanical properties. The third reagent is then also placed in the mold with the first and second reagents, defining at least one supplementary interface with at least one of them, to be subjected with them to the sintering operation, at least a portion of the supplementary interface or interfaces being rendered visible on the surface of the casing element upon the implementation of the material removal operation.

A wider range of possible variations in the hues and colors of the casing element manufactured in this way is thus obtained.

In this case, provision can also be made for the interface and the supplementary interface or each of the supplementary interfaces to exhibit between them one or more inclinations of between 0 and 20° so as to define a median plane for all of the interfaces, and for the machining step to be performed in such a way that the casing element has at least one face defining a median general plane exhibiting an inclination with reference to the median plane of all of the interfaces of between 10 and 90°.

Advantageously, provision can also be made for each of the reagents to comprise a maximum proportion by weight of pigment(s) of 15%.

Generally, provision can preferably be made for the sintering operation to consist of a flash sintering operation.

In this case, provision can advantageously be made for the flash sintering operation to comprise a step consisting in using an electrically conductive mold linked to two electrodes situated at a distance from one another and between which is applied an electrical voltage greater than 1 volt and less than or equal to 10 volts, preferably associated with an electrical current of between 1 and 25000 A, and between which is preferably applied a pressure of between 5 and 1000 MPa, for a duration of between 2 and 30 minutes.

Furthermore, provision can preferably be made for the flash sintering operation to then constitute the single heat treatment operation of the method applied to the mold while it contains the reagents.

The present invention relates also to a ceramic casing element, for the fields of horology or of jewelry, comprising first and second portions that are adjacent via an interface that is at least partially visible on the surface of the casing element, the first and second portions having different respective hues and/or colors and having respective natures such that the casing element is substantially homogeneous from the point of view of its structure and of its mechanical properties. The casing element according to the invention is characterized
by the fact that it has at least two transverse cutting planes that are mutually orthogonal and each of which cuts the two portions, and
by the fact that it has a unique appearance with variations of hue and/or of color on its surface, the distribution of which appears to be substantially random and is independent of any predefined pattern or of any function linked to the display of an indication.

Preferably, the casing element according to the invention has a structure such that the smallest dimension of each of the portions of different colors is less than or substantially equal to 5 mm.

Advantageously, the casing element according to the invention can be a horological casing element, notably a component of a watch case such as a middle, a bezel or a bottom, or of a wristlet for a wristwatch such as a link, a stud or a buckle, even a casing element of a piece of jewelry.

Generally, it may be preferable to provide for the tenacity between two adjacent portions, of different hues and/or colors, to vary by at most 5% along the extent of their interface.

### BRIEF DESCRIPTION OF THE DRAWINGS

Other features and advantages of the present invention will become more clearly apparent on reading the following detailed description of a preferred embodiment, given with reference to the attached drawings given by way of nonlimiting example and in which:

FIG. 1 represents a schematic diagram illustrating a first step of implementation of a method according to a preferred embodiment of the present invention,

FIG. 2 represents a schematic diagram illustrating a second step of implementation of the method according to the preferred embodiment of the present invention,

FIG. 3 represents a schematic diagram illustrating a third step of implementation of a method according to the preferred embodiment of the present invention,

FIG. 4 represents a schematic diagram illustrating a step of implementation of the method according to the preferred embodiment of the present invention, in relation to a supplementary example, and

FIGS. 5a and 5b represent schematic diagrams illustrating a preferred mode of characterization of a casing element according to the present invention, FIG. 5a corresponding to a casing element that does not match the features of the invention and FIG. 5b corresponding to a casing element according to the invention.

### EMBODIMENT(S) OF THE INVENTION

As was described previously, the manufacturing method according to the present invention consists notably in associating several reagents, at least one of which contains at least one pigment, in order to perform a simultaneous sintering of all of the reagents and obtain a ceramic product having portions that exhibit hues and/or colors that are different from one another.

This manufacturing method is based on the principle whereby the casing element obtained exhibits structural homogeneity, that is to say that it does not include any join which could embrittle it, and properties, notably mechanical, that are uniform over its entire surface, even throughout its volume.

Thus, a juxtaposition of layers of reagents of very different natures which would undergo a sintering, in order to obtain a casing element which would exhibit different portions of different hues and/or color after sintering, does not represent a satisfactory solution, since the casing element thus obtained would not exhibit the homogeneity that is sought.

In particular, an important feature to be taken into account, to achieve the homogeneity that is sought, is the fact that the associated different reagents must be chemically inert to one another and have similar sintering temperatures.

Similar temperatures within the meaning of the present invention should be understood to mean that the different sintering temperatures of the different reagents used should preferably lie within a range of the order of 20° C.

Consequently, only compositions in the form of powders exhibiting similar sintering temperatures should preferably be used in the context of the present method. Furthermore, when binders are used, they are preferably chosen from a same family of binders, even one and the same binder can be used for the different compositions to be associated with one another. The same applies for the stabilizing agent used in the different compositions involved. The respective proportions of binders, if appropriate, and of stabilizing agents used in the different compositions should be chosen such that the sintering temperatures of the different compositions remain similar to one another.

It will finally be noted that the addition of one or more pigments in a basic composition also influences the sintering temperature of the green body that is thus formed. Because of this, starting from a same basic composition, it is preferable to limit the proportion by weight of the pigment or pigments to 15% in the green body to limit the variations of the sintering temperature.

The detailed description which follows sets out to describe a method for manufacturing a ceramic casing element for the fields of horology or jewelry, according to a preferred embodiment of the present invention, as a nonlimiting illustrative example.

More specifically, according to the embodiment illustrated and described, the casing element 1 manufactured by the implementation of the manufacturing method takes the form of a bezel for a watch case but, of course, the person skilled in the art will be able to implement the manufacturing method according to the invention, as defined in the claims, to produce other casing elements without departing from the scope of the present invention.

The method according to the invention consists in preparing different reagents or green bodies, in order to perform the sintering thereof when they are placed together in a mold, by introducing at least one pigment into at least one basic composition to define one of the reagents or green bodies.

At least one other green body can be used as reagent without necessarily including any pigment.

As an alternative, it is possible to add the same pigment to the other basic composition but according to different proportions to obtain variations of hue on the casing element that is finally obtained.

As mentioned above, it is also possible to introduce at least one different pigment into each of the basic compositions used to manufacture the desired casing element.

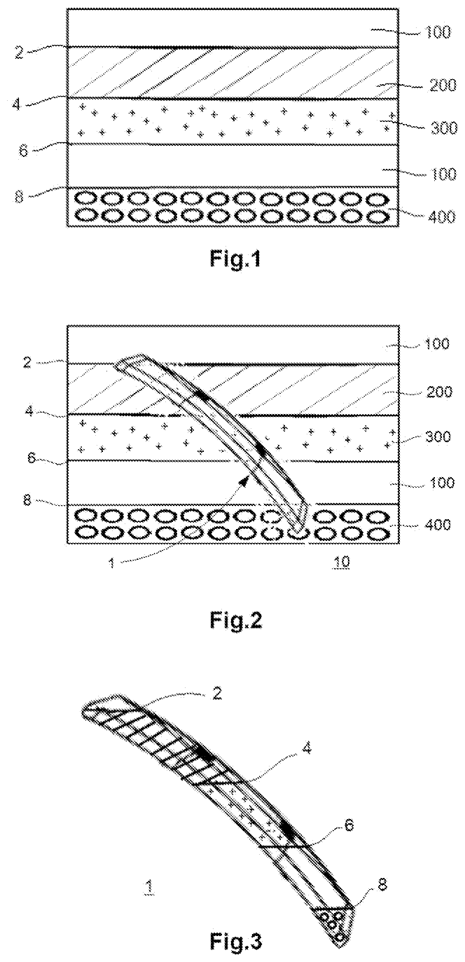

FIGS. 1 to 3 represent schematic diagrams illustrating different steps of a manufacturing method according to the preferred embodiment, in which one and the same pigment or one and the same mixture of pigments is added to one same basic composition, but according to different proportions, to define four different reagents or green bodies, the respective sintering temperatures of which are similar.

It is for example possible to consider the preparation of a basic composition intended to lead to a ceramic after a sintering operation, from zirconia (ZrO2), notably with a granulometry suited to the properties desired for the ceramic that is obtained. The person skilled in the art will have no particular difficulty in choosing a powder and its granulometry according to his or her specific needs.

Provision can be made for the basic composition to comprise a stabilizing agent, for example, here, yttrium oxide (Y₂O₃), optionally, as well as a binder, for example polyvinyl alcohol (PVA), each in proportions that can range from 0 to 10% by weight.

In accordance with the present invention, the preparation of several different reagents can be provided by adding to the above basic composition different proportions of one and the same pigment, the proportion by weight of zirconia in the final green body preferably lying between 80 and 98%.

It will for example be possible to use, as a nonlimiting illustrative example, an iron oxide (red coloring, or brown to black depending on the degree of oxidation of the iron), an aluminum oxide (white coloring), a bismuth oxide (blue coloring) and/or a chromium oxide (green coloring).

The introduction of the pigment or of the mixture of pigments will preferably be able to be performed so as to obtain green bodies in which the pigment or pigments represent a proportion of the order of 0 to 15% by weight.

Thus, it is for example possible to prepare four reagents or green bodies, 100, 200, 300 and 400, based on the composition mentioned above and containing different proportions of pigment(s) according to the information in the table below:

| | | Intensity of the color |
|---|---|---|
| Layer reference | Proportion of pigment(s) | obtained |
| 100 | Low | Very pale hue |
| 200 | Maximum | Very dark hue |
| 300 | Average | Weak hue |
| 400 | High | Dark hue |

These reagents 100 to 400 are then placed in a mold to undergo a sintering operation, in the form of adjacent layers, as illustrated in FIG. 1, the reagent 100 being used to produce two layers here, as a nonlimiting illustrative example.

Each layer will advantageously be able to have an average thickness of the order of 0.5 to 5 mm, preferably 0.5 to 3 mm.

The distribution of the layers, here substantially planar, gives rise to four interfaces 2, 4, 6 and 8, each interface being defined at the join between two adjacent layers.

These interfaces 2, 4, 6 and 8 are all substantially planar and parallel here, as a nonlimiting illustrative example, defining the orientation of a median plane for all of the interfaces. Of course, the person skilled in the art will be able to deposit different layers according to his or her specific needs, notably layers of variable thickness, possibly defining interfaces which would not necessarily be parallel to one another.

As set out above, the placing of the different reagents in the mold does not entail any particular precise control of the way in which the different layers are arranged with respect to one another, given that the method according to the invention does not aim to produce a predefined pattern on the casing element that is finally obtained.

The sintering operation leads to a ceramic product, in the form of a block 10, the form of which is defined by the form of the mold used, illustrated schematically in FIG. 2.

It can be seen that this ceramic product has different portions, in its mass, exhibiting hues that differ from one another, as a function of the proportion of pigment(s) used for the doping of the corresponding reagent.

Generally, the sintering operation according to the present invention preferably takes the form of a flash sintering operation (or SPS, “Spark Plasma Sintering”, or electric current assisted sintering or FAST, “Field-Assisted Sintering Technique”).

More specifically, provision can be made for this flash sintering operation to include a step consisting in using an electrically conductive mold linked to two electrodes situated at a distance from one another and between which is applied an electrical voltage greater than 0 volt and less than or equal to 10 volts, preferably associated with the passage of an electrical current of between 1 and 25000 A between the two electrodes. This electrical current makes it possible at least to heat up the mold, with a heating which can be very rapid (of the order of 500 to 1000° C./min), even also the reagents when they are electrically conductive.

The application of a pressure of between 5 and 1000 MPa makes it possible to speed up the sintering, sometimes reduce the sintering temperature (therefore the intensity of the current applied) and improve the densification of the product obtained after sintering. Generally, the pressure is applied directly by the electrodes themselves and is consequently unidirectional.

Typically, the flash sintering operation has a duration of between 2 and 30 minutes depending on the nature of the reagents and operational conditions retained. It can be produced while the mold is maintained in a vacuum or in a controlled atmosphere (for example in argon, hydrogen or nitrogen).

It will be noted that, in the case of the flash sintering, the use of binders is not necessary. Also, in this case, the flash sintering operation constitutes the sole heat treatment operation applied to the mold while it contains the reagents, given that no debinding step is required.

Referring to the document JP 2014-12615 A cited above, it will be noted that the present method makes it possible not only to reduce the duration of the sintering operation, switching from several hours to a few tens of minutes at most, but also to dispense with the hot isostatic compression (HIP) step that is essential in the prior method to obtain the mechanical properties desired for the final product.

The manufacturing method according to the present invention provides a step of machining of the ceramic product obtained that makes it possible to obtain a casing element 1, here a bezel for a watch case, that exhibits variations of hue and/or of color on its surface.

To this end, the machining step advantageously comprises at least one material removal operation along a path intersecting at least one of the interfaces 2, 4, 6 and 8, such that at least a portion of this interface is visible on the surface of the casing element 1.

FIG. 2 schematically illustrates a possible positioning of the bezel in the ceramic block 10 that makes it possible to simultaneously render all the interfaces 2, 4, 6 and 8 visible on the surface of the bezel once the machining step is completed (the bezel is octagonal here, as a nonlimiting illustrative example, which explains the presence of edges regularly distributed on its periphery). To this end, the casing element 1, here having a general form that makes it possible to define a median general plane thereof, the path followed by the removal of material is preferably chosen in such a way that this median general plane is inclined with respect to the median plane for all of the interfaces.

Depending on the final effect that is desired, on the number of layers, on their thickness, on the form and on the dimensions of the casing element, an infinity of different results can be obtained according to the orientation of the path followed to perform the removal of material for a given ceramic block 10.

Generally, it will notably be possible to provide, when the block 10 comprises at least two interfaces, for them to advantageously define two respective median planes exhibiting a relative inclination of the order of 0 to 20°. Moreover, it will also be possible to provide for the median general plane of the casing element 1, or of at least one of its faces if appropriate, to have an inclination with reference to the median plane of all of the interfaces of between 10 and 90°.

The ceramic block 10 is then machined, preferably using a CNC machine or possibly by laser, to release the bezel from it as illustrated in FIG. 3.

FIG. 3 shows that each of the four interfaces 2, 4, 6 and 8 is visible on the surface of the casing element 1.

The machining step according to the present invention is consequently relatively simple, depending on the form of the casing element to be manufactured, since it consists simply in freeing the casing element from the ceramic block obtained after the sintering operation. Once the overall form of the casing element is defined, it simply has to be applied to the ceramic block with an orientation that makes it possible to cut the interface or interfaces between the regions of different colors.

Generally, the person skilled in the art will have no particular difficulty in adapting the present teaching according to his or her needs, to define a suitable number of layers, and their thickness or the nature of their composition, as long as the green bodies used are such that, when they are subjected together to a sintering operation, a ceramic product is obtained that is substantially homogeneous from the point of view of its structure and of its mechanical properties.

Different green bodies will now be presented, as supplementary nonlimiting examples, as well as associated operational conditions that make it possible to manufacture a casing element 1 according to the present invention.

It will thus be possible to prepare, for example, a composition based on zirconia associated with yttrium oxide as stabilizing agent, in a proportion of between 1 and 5% with respect to the zirconia.

A binder will advantageously be able to be added to obtain a ceramic paste including a proportion by weight of binder of between 0 and 7% with respect to the ceramic paste. In a nonlimiting manner, the binder will be able to be chosen from the group comprising polyvinyl alcohol (PVA), polyethylene glycol (PEG), polyoxymethylene (POM), or even polyvinyl pyrrolidine.

As already mentioned above, the preparation of several different green bodies is then advantageously provided by adding to the basic composition different proportions of one and the same pigment or of different pigments, with similar or different proportions.

It will for example be possible to use the pigments cited previously, notably an iron oxide (red coloring, or brown to black depending on the degree of oxidation of the iron), an aluminum oxide (white coloring), a bismuth oxide (blue coloring) and/or a chromium oxide (green coloring). The addition of pigment(s) will preferably be able to be performed so as to obtain green bodies in which the pigment or pigments represent a proportion of the order of 0 to 15% by weight.

The green bodies thus obtained are compatible with one another from the point of view of the present invention, that is to say that they have respective sintering temperatures that are similar to one another.

The green bodies can be disposed alternately in a mold in the form of layers, as described previously, preferably by injection under pressure. It is notably possible to alternately place white, green, red (and/or brown to black) and blue layers from the reagents described above, in any order. Each layer will preferably be able to have a thickness of the order of 0.5 to 5 mm.

A conventional sintering operation is then applied to the mold containing the different layers of reagents or green bodies, at a temperature of between 800 and 1600° C.

Alternatively, and preferably, no binder is used and the powders are placed in a mold for flash sintering (typically graphite, silicon carbide or tungsten carbide for example), the latter being then subjected to a flash sintering operation.

The person skilled in the art will be able to use any suitable equipment to implement the flash sintering operation without departing from the scope of the present invention as defined by the attached claims. As an example, he or she will be able to use one or other SPS machine marketed by the company Fuji Electronics (see https://www.fdc.co.jp/sps/products/e_products.html).

The flash sintering operation will be able to include one or more temperature-rising ramps, depending on the nature of the reagents to be treated, without departing from the scope of the present invention as defined by the attached claims.

After cooling, the ceramic block obtained after sintering is machined, for example using a CNC machine, to release from it the desired casing element, notably intended to be used in the fields of horology or of jewelry.

As already mentioned in relation to the example illustrated in FIGS. 2 and 3, it is advantageous to provide, in this machining step, for the median general plane of the casing element, or of at least one of its faces if appropriate, to exhibit an inclination with reference to the median plane of all of the interfaces of between 10 and 90°.

By virtue of these characteristics there is an assurance that a maximum number of interfaces between the different layers is rendered visible on the surface of the casing element finally obtained, thus conferring a great variety of hues and/or colors on its surface.

In order to characterize the conditions for obtaining a ceramic casing element according to the present invention, that is to say the conditions that make it possible to consider that a ceramic element is substantially homogeneous from the point of view of its structure and of its mechanical properties, an additional exemplary embodiment will now be described.

As an illustration, this additional example provides for the production of a ceramic casing element comprising six different portions exhibiting different respective colors and hues, because of the use of two different pigments or pigment mixtures (C1 and C2), in variable proportions, as indicated in the table below.

| | | Proportion of | |
|---|---|---|---|
| Layer | Color of the | pigment of the hue | Intensity of the |
| reference | layer | considered | color obtained |
| 104 | C1 | Weak | Very pale hue |
| 204 | C1 | Average | Pale hue |
| 304 | C1 | High | Average hue |
| 404 | C2 | Average | Dark hue |
| 504 | C2 | Weak | Average hue |
| 604 | C2 | Maximum | Very dark hue |

FIG. 4 represents a schematic view of a ceramic block 40 obtained in accordance with the operational conditions presented above.

In fact, the present supplementary exemplary embodiment provides for the preparation of several different green bodies by adding to a same basic composition different proportions of two pigments or of two different pigment mixtures, according to variable proportions, before disposing these green bodies in a mold in the form of superposed layers, and making them undergo a sintering operation.

The block 40 is then obtained, with six different portions corresponding to the layers 104, 204, 304, 404, 504 and 604, as illustrated in FIG. 4.

A measurement of the tenacity can be performed to define an acceptable level of structural homogeneity of the block 40, by applying a load to the latter in a direction transversal to the different layers, i.e. substantially parallel to the plane P referenced in FIG. 4.

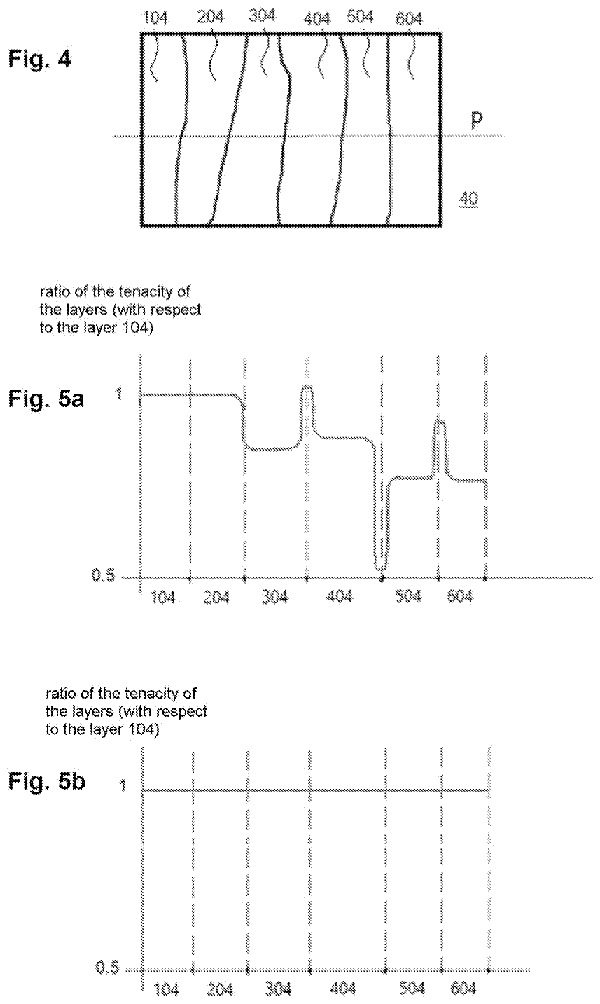

FIG. 5a represents a schematic diagram illustrating the ratio between the tenacity at different points of a ceramic block that does not correspond to the present invention, in a direction parallel to the plane P, and the tenacity of the first layer 104.

It can be seen that the tenacity varies notably along the ceramic block, which is reflected by a certain structural heterogeneity which can give rise to a rupturing of the block under certain particular mechanical strains, which is not desirable in the context of the present invention.

FIG. 5b represents a schematic diagram illustrating the ratio between the tenacity at different points of a ceramic block according to the present invention, in a direction parallel to the plane P, and the tenacity of the first layer 104.

The diagram of FIG. 5b schematically represents the ideal case whereby the tenacity is constant all along the plane P, which reflects the fact that the corresponding ceramic block is homogeneous from the point of view of its structure and of its mechanical properties, in accordance with the criterion of the present invention.

In practice, it will preferably be possible to consider that the criterion of homogeneity according to the present invention is fulfilled when the tenacity between two adjacent layers varies by 5% at most.

By virtue of the manufacturing method which has just been presented, it is possible to produce a ceramic casing element with an appearance that is both original and unique, through its plurality of hues and/or of colors, and with mechanical properties equivalent to those of a conventional ceramic casing element of uniform hue and color.

The implementation of the present invention is not limited to the compositions provided as nonlimiting examples. Indeed, the person skilled in the art will have no particular difficulty in adapting the present teaching to the implementation of a method for manufacturing a ceramic casing element of a nature different from those described, and manufactured from compositions of natures that differ from those of the examples provided, without in any way departing from the scope of the invention as defined by the claims.

1. A method for manufacturing a ceramic casing element for the fields of horology or jewelry, comprising steps consisting in:
preparing a first basic composition, comprising a powder suitable to produce a ceramic when it is subjected to a sintering operation,
preparing a second basic composition, comprising a powder suitable to produce a ceramic when it is subjected to a sintering operation,
treating at least one of said first basic composition and said second basic compositions, prior to the implementation of said sintering operation, to introduce therein at least one pigment and define first and second respective reagents,
said first and second respective reagents having respective natures that are similar but different from one another such that, when they are subjected together to a sintering operation, a ceramic product is obtained that is substantially homogeneous from the point of view of its structure and of its mechanical properties, and that said ceramic product that is finally obtained exhibits variations of hue and/or of color,
placing said first and second respective reagents in a mold in the form of at least two layers that are at least partially adjacent to define between them an interface of predefined form,
implementing a sintering operation applied to the mold containing said first and second respective reagents,
wherein the method further comprises at least one step of machining of said ceramic product obtained after said sintering operation, comprising at least one material removal operation along a path intersecting said interface, in such a way that at least a portion of said interface is visible on the surface of said casing element, and that the latter exhibits a unique appearance with variations of hue and/or of color on its surface, the distribution of which appears to be substantially random and is independent of any predefined pattern or of any function linked to the display of an indication.

2. The method of claim 1, wherein said first and second respective reagents are placed in said mold in the absence of any precise control as to the manner in which they are distributed with respect to one another inside said mold and which would aim to produce a predefined pattern.

3. The method of claim 1, further comprising a supplementary step of preparation of a third reagent, comprising a powder suitable to produce a ceramic when it is subjected to a sintering operation, said third reagent having a nature that is similar but different from that of at least one out of said first and second respective reagents and being chosen in such a way that, when said first and second respective reagents and said third reagents are subjected together to a sintering operation, a ceramic product is obtained that is substantially homogeneous from the point of view of its structure and of its mechanical properties,
wherein said third reagent is also placed in the mold with said first and second respective reagents, defining at least one supplementary interface with at least one of them, to be subjected with them to the sintering operation, at least a portion of said or of each supplementary interface being rendered visible on the surface of the casing element upon the implementation of the material removal operation.

4. The method of claim 1, wherein said interface has a median plane and wherein said machining step is performed in such a way that said casing element has at least one face defining a median general plane exhibiting an inclination of between 10 and 90° with reference to said median plane of the interface.

5. The method of claim 3, wherein said interface and said supplementary interface or each of said supplementary interfaces, exhibit between them one or more inclinations of between 0 and 20° so as to define a median plane for all of said interfaces and said supplementary interfaces, and in that said machining step is performed in such a way that said casing element has at least one face defining a median general plane exhibiting an inclination of between 10 and 90° with reference to said median plane of all of said interface and said supplementary interfaces.

6. The method of claim 1, wherein each of said first and second respective reagents comprises a maximum proportion by weight of pigments of 15%.

7. The method of claim 1, wherein said first and second respective reagents comprise identical pigments in different proportions.

8. The method of claim 1, wherein at least one of said first and second respective reagents contains particles of at least one precious metal.

9. The method of claim 1, wherein said sintering operation consists of a flash sintering operation.

10. The method of claim 9, wherein said flash sintering operation comprises a step consisting in using an electrically conductive mold linked to two electrodes situated at a distance from one another and between which is applied an electrical voltage greater than 1 volt and less than or equal to 10 volts, preferably associated with an electrical current of between 1 and 25000 A, and between which is preferably applied a pressure of between 5 and 1000 MPa, for a duration of between 2 and minutes.

11. The method of claim 9, wherein said flash sintering operation constitutes the single heat treatment operation of the method applied to said mold while it contains at least said first and second respective reagents.

12. A ceramic casing element, for the fields of horology or of jewelry, comprising at least first and second portions that are adjacent via an interface that is at least partially visible on the surface of the casing element, said first and second portions exhibiting respective hues and/or colors that are different and being of respective natures such that the casing element is substantially homogeneous from the point of view of its structure and of its mechanical properties,
wherein the ceramic casing element has at least two transverse cutting planes that are mutually orthogonal and each of which cuts said at least first and second portions, and
wherein it exhibits a unique appearance with variations of hue and/or of color on its surface, the distribution of which appears to be substantially random and is independent of any predefined pattern or of any function linked to the display of an indication.

13. The casing element of claim 12, wherein it comprises at least a third portion exhibiting a hue and/or a color that is different from that of at least one of said first and second portions and being of a nature such that the casing element is substantially homogeneous from the point of view of its structure and of its mechanical properties, said third portion defining at least one supplementary interface with at least one of said first and second portions, and
wherein each of said transverse cutting planes cuts at least two of said first, second and third portions.

14. The casing element of claim 12, wherein the smallest dimension of each of said first and second portions is less than or substantially equal to 5 mm.

15. The casing element of claim 12, wherein it is a horological casing element, including a component of a watch case such as a middle, a bezel or a bottom, or a wristlet for a wristwatch such as a link, a stud or a buckle, or a casing element of a piece of jewelry.

16. The casing element of claim 12, wherein the tenacity between two adjacent portions varies by at most 5% along the extent of said interface.

17. The method of claim 3, wherein each of said first and second respective reagents and said third reagent comprises a maximum proportion by weight of pigments of 15%.

18. The method of claim 3, wherein said first and second respective reagents and said third reagent comprise identical pigments in different proportions.

19. The casing element of claim 13, wherein the smallest dimension of each of said first, second and third portions is less than or substantially equal to 5 mm.

20. The casing element of claim 13, wherein the tenacity between two adjacent portions varies by at most 5% along the extent of the corresponding interface or supplementary interface.
